(19) United States
(12) Patent Application Publication
(10) Pub. No.: US 2012/0314080 A1
(43) Pub. Date: Dec. 13, 2012

(54) GAS LEAKAGE DETECTING SYSTEM AND METHOD

(76) Inventors: Yeu Yong LEE, Seoul (KR); Myung Woon SONG, Suwon-si (KR)

(21) Appl. No.: 13/489,256

(22) Filed: Jun. 5, 2012

(30) Foreign Application Priority Data
Jun. 10, 2011 (KR) 10-2011-0055917

(51) Int. Cl. H04N 7/18

(52) U.S. Cl. 348/159; 348/E07.085

(57) ABSTRACT

A gas leakage detecting system for detecting leaking gas includes a camera set having visible-light cameras and infrared cameras photographing a gas monitoring area, a composite image coupling unit that couples visible-light images captured by the visible-light cameras and infrared images captured by the infrared cameras, extracts gas leakage points from the coupled infrared images when a temperature of a specific gas, which was previously stored in a database (DB), is detected, and creates a composite of the extracted gas leakage points and the visible-light images to create composite images, a screen output unit outputting the composite images created by the composite image coupling unit to an administrator terminal so as to enable an administrator to identify the composite images, and a control unit analyzing a type of the gas and a gas leakage area from the temperature of the specific gas detected from the gas leakage points.

### CROSS REFERENCE

This application claims foreign priority under Paris Convention and 35 U.S.C. §119 to Korean Patent Application No. 10-2011-0055917, filed Jun. 10, 2011 with the Korean Intellectual Property Office.

### BACKGROUND OF THE INVENTION

1. Field of the Invention

The present invention relates, in general, to a gas leakage detecting system and method, and more particularly to a gas leakage detecting system and method, capable of easily discovering gas leakage points by photographing a gas monitoring area using a plurality of visible-light cameras and infrared cameras, by extracting the gas leakage points from infrared images captured by the infrared cameras, and by compositing the gas leakage points into visible-light images, so that persons and an administrator who are located near the gas leakage points can take rapid response measures by analyzing the type of gas and a range of gas leakage from a temperature of a specific gas detected in the infrared images.

2. Description of the Related Art

Generally, gases such as liquefied natural gas (LNG), liquefied petroleum gas (LPG), chemical gases, and oil vapor gas are mainly used as industrial fuel at factories or thermal power plants. These gases are flammable, and thus are in danger of causing a fire or explosion in the event of their leaking and causing tremendous damage to property and human life. As such, to prevent gas leakage in advance and to rapidly detect, if any, the gas leakage points to prevent the spreading of the damage, measures need to be taken. To this end, recently, gas leakage detecting systems have been successively introduced into places where there is a danger of gas leakage, such as factories or thermal power plants.

However, according to the conventional gas leakage detecting systems, gas detectors are separately installed at many areas that are afraid of gas leakage points. Since the gas detectors are relatively expensive, installation cost is increased. Further, in the case of an outdoor installation, the gas detectors are frequently subjected to a drop in performance and not operating after being installed, so that the installation has problems.

Further, there is the need to develop a system that is designed to give warning to persons including handicapped persons with vision and hearing disabilities who are located near the gas leakage points so as to enable the persons to escape from the gas leakage points.

### SUMMARY OF THE INVENTION

Accordingly, the present invention has been made keeping in mind the above problems occurring in the related art, and an object of the present invention is to provide a gas leakage detecting system and method, in which a gas monitoring area is photographed using a camera set having visible-light cameras and infrared cameras, and images captured by the cameras are coupled, thereby extracting (identifying and detecting) gas leakage points in the gas monitoring area form the coupled images, so that persons located near the gas leakage points and an administrator of the gas monitoring area are allowed to escape from or repair the gas leakage points.

Further, another object of the present invention is to provide a gas leakage detecting system and method, in which visible-light images and infrared images are recorded and stored in a storage unit when a temperature of a specific gas which was previously stored in a database (DB) is detected by a composite image coupling unit, thereby enabling an administrator to analyze the stored images later in future to accurately determine a gas leak time and gas leakage points to carry out maintenance.

Further, another object of the present invention is to provide a gas leakage detecting system and method, in which, when a temperature of a specific gas which was previously stored in a database (DB) is detected by a composite image coupling unit, a pilot lamp is turned on and off so as to enable persons located near a gas monitoring area to discover a position of a storage cabinet in which gas masks are stored.

Further, another object of the present invention is to provide a gas leakage detecting system and method, in which, when a specific gas leaks from a gas monitoring area, a text message for informing about the gas leak is sent to mobile phones by a message sending module so as to guide escape within the shortest amount of time.

In order to achieve the above object, according to an aspect of the present invention, there is provided a gas leakage detecting system for detecting leaking gas, which includes: a camera set having visible-light cameras and infrared cameras photographing a gas monitoring area; a composite image coupling unit that couples visible-light images captured by the visible-light cameras and infrared images captured by the infrared cameras, extracts gas leakage points from the coupled infrared images when a temperature of a specific gas, which was previously stored in a database (DB), is detected, and makes a composite of the extracted gas leakage points and visible-light images to create composite images; a screen output unit outputting the composite images created by the composite image coupling unit to an administrator terminal so as to enable an administrator to ascertain the composite images; and a control unit analyzing a type of the gas and a range of gas leakage from the temperature of the specific gas detected at the gas leakage points. The control unit records the visible-light images and the infrared images, and stores the recorded images in a storage unit when the temperature of the specific gas which was previously stored in the DB is detected by the composite image coupling unit.

Here, the camera set may further include a camera driver that is allowed to control focusing and tracking operations of the visible-light cameras and the infrared cameras.

Further, any one of the cameras may rotate by an angle of 360° to photograph the gas monitoring area, and when the visible-light images and the infrared images which the camera captures while rotating by an angle of 360° are output to the administrator terminal, the control unit may process the captured images into a panorama image file so as continuously display the captured images on the administrator terminal.

Also, the composite image coupling unit may include: a visible-light image coupler coupling the visible-light images captured by the visible-light cameras; an infrared image coupler coupling the infrared images captured by the infrared cameras using information which the visible-light image coupler uses to couple the visible-light images; a gas leak extractor extracting the gas leakage points, from which the temperature of the specific gas previously stored in the DB is detected, from the infrared images coupled by the infrared image coupler; and an image compositor making a composite of the gas leakage points extracted by the gas leak extractor and the visible-light images coupled by the visible-light image coupler.

Further, the visible-light image coupler may calculate pixel positions to join the visible-light images, and couple the visible-light images based on the calculated pixel positions.

Also, the infrared images may have a resolution lower than that of the visible-light images. The infrared image coupler may conduct decimation on the pixel positions calculated by the visible-light image coupler, calculates pixel positions of the infrared images, and couples the infrared images based on the calculated pixel positions of the infrared images.

Here, the control unit may analyze the type of the gas and the range of gas leakage to determine a gas leakage state as being safe or dangerous, and control a warning unit so as to enable persons located at the gas monitoring area and an administrator of the gas monitoring area to escape from or repair the gas leakage points according to the gas leakage state.

Further, the control unit may determine that the gas leakage state is safe when the specific gas leaking from the gas leakage points does not have an influence on a human body and when a quantity of gas leaked is less than a predetermined value, control the screen output unit so as to output the gas leakage points from which the gas leaks, the type of the gas, and the range of gas leakage to the administrator terminal, and inform an administrator so that the gas leakage points can be repaired. The control unit may determine that the gas leakage state is dangerous when the specific gas leaking from the gas leakage points has an influence on a human body and when a temperature corresponding to a temperature of the human body is detected from the specific gas, control the screen output unit so as to output the gas leakage points from which the gas is leaking, the type of the gas, and the range of gas leakage to the administrator terminal, and inform an administrator so as to be able to repair the gas leakage points, and simultaneously control the warning unit so as to output a warning sound and announcement to persons located at the gas leakage points and to enable the persons to escape from the gas leakage points.

Further, when the control unit determines that the gas leakage state is dangerous, the control unit may turn on and off a pilot lamp so as to enable persons located at the gas monitoring area to discover a position of a storage cabinet in which gas masks are stored.

In addition, when the camera set monitoring the gas monitoring area is installed in a building or a specific area, and when the temperature of the specific gas which was previously stored in the DB is detected by the composite image coupling unit, the control unit may control a message sending module so as to allow people who are in the building or the specific area previously stored in the DB to escape from the gas monitoring area within a shortest amount of time and so as to send a text message to mobile phones of the people in order to inform the people about a gas leakage.

According to an aspect of the present invention, there is provided a gas leakage detecting method, which includes the processes of: (a) photographing a gas monitoring area using a camera set having visible-light cameras and infrared cameras; (b) coupling visible-light images captured by the visible-light cameras and infrared images captured by the infrared cameras, extracting gas leakage points from the coupled infrared images when a temperature of a specific gas, which was previously stored in a database (DB), is detected, and making a composite of the extracted gas leakage points and the composite visible-light images to create composite images; (c) outputting the composite images created in the process (b) to an administrator terminal and analyzing, by a control unit, a type of the gas and a range of gas leakage from the temperature of the specific gas detected from the gas leakage points. The control unit records the visible-light images and the infrared images, and stores the recorded images in a storage unit when the temperature of the specific gas which was previously stored in the DB is detected in the process (b).

Here, the camera set may further include a camera driver that is allowed to control focusing and tracking operations of the visible-light cameras and the infrared cameras.

Further, any one of the cameras may rotate by an angle of 360° to photograph the gas monitoring area. When the visible-light images and the infrared images which the camera captures while rotating by an angle of 360° are output to the administrator terminal, the control unit may process the captured images into a panorama image file so as to be continuously displayed on the administrator terminal.

Further, the process (b) may include the sub-processes of: (b1) coupling, by a visible-light image coupler, the visible-light images captured by the visible-light cameras; (b2) coupling, by an infrared image coupler, the infrared images captured by the infrared cameras using information which the visible-light image coupler uses to couple the visible-light images; (b3) extracting the gas leakage points, from which the temperature of the specific gas previously stored in the DB is detected, from the infrared images coupled in the sub-process (b2); and (b4) making a composite of the gas leakage points extracted in the sub-process (b3) and the visible-light images coupled by the visible-light image coupler.

Further, the sub-process (b1) may include calculating pixel positions used to join the visible-light images, and coupling the visible-light images based on the calculated pixel positions.

Also, in the sub-process (b2): the infrared images may have a resolution lower than that of the visible-light images, and the infrared image coupler may conduct decimation on the pixel positions calculated by the visible-light image coupler, calculate pixel positions of the infrared images, and couple the infrared images based on the calculated pixel positions of the infrared images.

Further, the control unit may analyze the type of the gas and the range of gas leakage to determine a gas leakage state as being safe or dangerous, and control a warning unit so as to enable persons located at the gas monitoring area and an administrator of the gas monitoring area to escape from or repair the gas leakage points according to the gas leakage state.

Also, the control unit may determine that the gas leakage state is safe when the specific gas leaking from the gas leakage points has no influence on a human body and when a quantity of gas leaked is less than a predetermined value, control the screen output unit so as to output the gas leakage points from which the gas leaks, the type of the gas, and the range of gas leakage to the administrator terminal, and inform an administrator so that the gas leakage points can be repaired. The control unit may determine that the gas leakage state is dangerous when the specific gas leaking from the gas leakage points has an influence on a human body and when a temperature corresponding to a temperature of the human body is detected from the specific gas, control the screen output unit so as to output the gas leakage points from which the gas is leaking, the type of the gas, and the range of gas leakage to the administrator terminal, and inform an administrator so that the gas leakage points can be repaired, and simultaneously control the warning unit so as to output a warning sound and announcement to persons located at the gas leakage points and to enable the persons to escape from the gas leakage points.

Further, when the control unit determines that the gas leakage state is dangerous, the control unit may turn on and off a pilot lamp so as to enable persons located in the gas monitoring area to discover a position of a storage cabinet in which gas masks are stored.

In addition, when the camera set monitoring the gas monitoring area is installed in a building or a specific area, and when the temperature of the specific gas which was previously stored in the DB is detected in the process (b), the control unit may control a message sending module so as to allow people who are in the building or the specific area previously stored in the DB to escape from the gas monitoring area within a shortest amount of time and so as to send a text message for informing the people about a gas leakage to mobile phones of the people.

According to the gas leakage detecting system and method of the present invention as described above, the gas monitoring area is photographed using the camera set having the visible-light cameras and the infrared cameras, and the images captured by the cameras are coupled. Thereby, the gas leakage points where gas is leaking from in the gas monitoring area are extracted from the coupled images, so that persons located near the gas leak point and an administrator of the gas monitoring area are allowed to escape from or repair the gas leakage points.

Further, when the temperature of the specific gas which was previously stored in the database (DB) is detected by the composite image coupling unit, the visible-light images and the infrared images are recorded and stored in the storage unit. Thereby, an administrator can analyze the stored images later in the future to accurately ascertain a gas leak time and gas leakage points to carry out maintenance.

Further, when the temperature of the specific gas which was previously stored in a database (DB) is detected by the composite image coupling unit, the pilot lamp is turned on and off so as to enable persons located near the gas monitoring area to discover a position of the storage cabinet in which the gas masks are stored.

In addition, when the specific gas leaks from the gas monitoring area, the text message for informing about the gas leak is sent to mobile phones by the message sending module so as to enable people to escape within the shortest amount of time.

### BRIEF DESCRIPTION OF THE DRAWINGS

The above and other objectives, features and further advantages of the present invention will be more clearly understood from the following detailed description when taken in conjunction with the accompanying drawings, in which:

FIG. 1 is a block diagram showing a gas leakage detecting system according to an exemplary embodiment of the present invention;

FIG. 2 is a block diagram showing a composite image coupling unit of the gas leakage detecting system according to the exemplary embodiment of the present invention;

FIG. 3 shows an example of an overlapping portion of a photographing region of the gas leakage detecting system according to the exemplary embodiment of the present invention;

FIG. 4 shows operation of the gas leakage detecting system according to the exemplary embodiment of the present invention;

FIG. 5 is a flow chart showing a gas leakage detecting method according to an exemplary embodiment of the present invention; and

FIG. 6 is a flow chart showing an image composition process of the gas leakage detecting method according to the exemplary embodiment of the present invention.

### DETAILED DESCRIPTION OF THE INVENTION

The details of other exemplary embodiments are included in the detailed description and the drawings.

Advantages and features of the present invention and methods for achieving them will be made clear from exemplary embodiments described below in detail with reference to the accompanying drawings. However, the present invention is not limited to exemplary embodiments described herein and will be implemented in various forms. The exemplary embodiments are provided only for example purposes to impart a person of ordinary skill in the art with a full understanding of the disclosures of the present invention and the scope of the present invention. Therefore, the present invention will be defined only by the scope of the appended claims. Similar reference numerals designate similar components throughout the specification.

Hereinafter, a gas leakage detecting system and method according to exemplary embodiments of the present invention will be described with reference to the accompanying drawings.

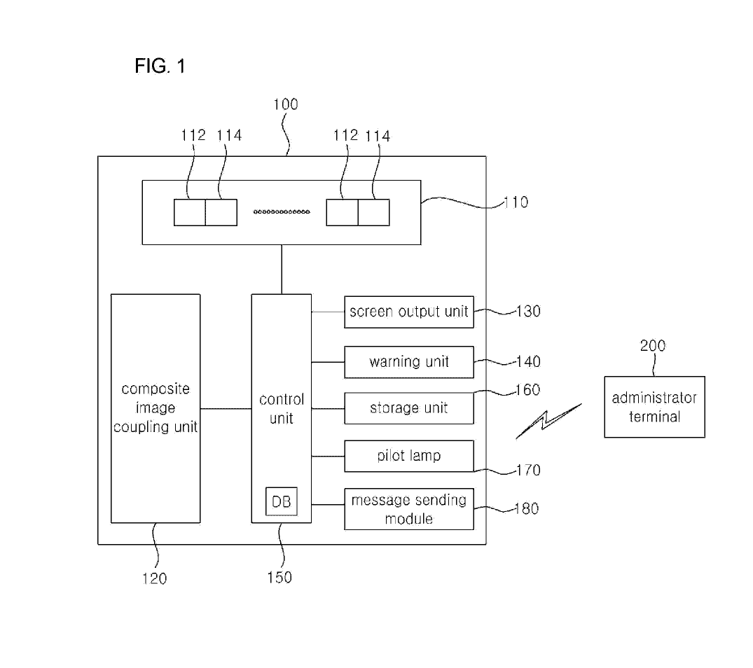

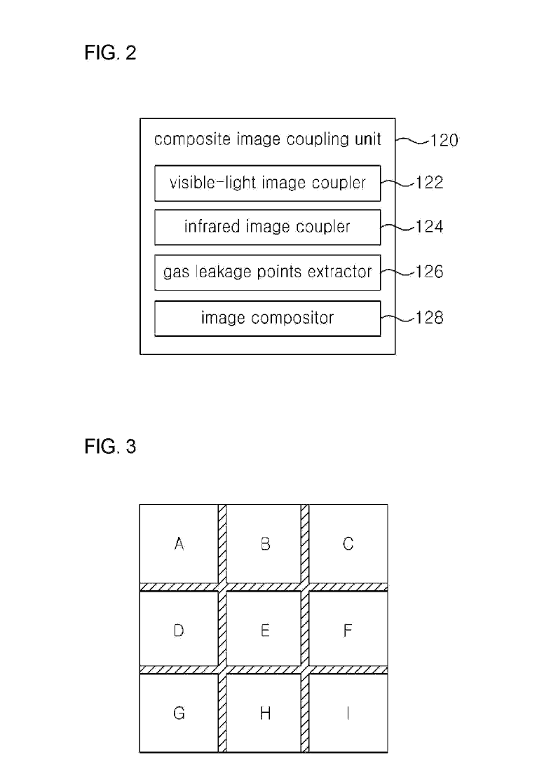

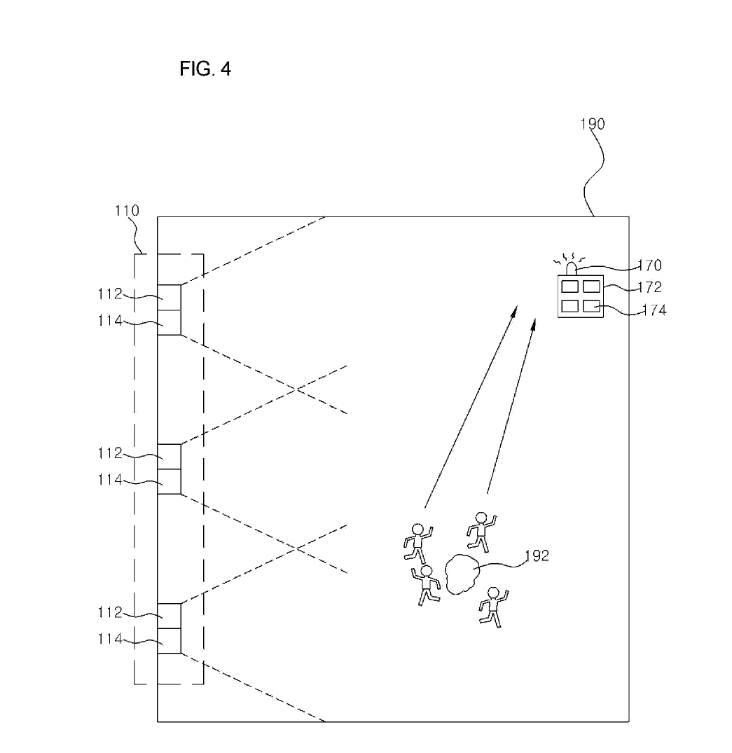

FIG. 1 is a block diagram showing a gas leakage detecting system according to an exemplary embodiment of the present invention. FIG. 2 is a block diagram showing a composite image coupling unit of the gas leakage detecting system according to the exemplary embodiment of the present invention. FIG. 3 shows an example of an overlapping portion of a photographing region of the gas leakage detecting system according to the exemplary embodiment of the present invention. FIG. 4 shows operation of the gas leakage detecting system according to the exemplary embodiment of the present invention.

The gas leakage detecting system 100 according to an exemplary embodiment of the present invention includes a camera set 110, a composite image coupling unit 120, a screen output unit 130, and a control unit 150.

The camera set 110 is made up of a plurality of cameras, including a plurality of visible-light and infrared cameras 112 and 114 that photograph a gas monitoring area 190.

Further, the camera set 110 is configured so that the visible-light cameras 112 and the infrared cameras 114 are formed in one body.

Here, each visible-light camera 112 refers to a typical camera that acquires video information based on light detection.

Each infrared camera 114 is a thermal imaging camera, and is different from the typical camera in that it operates like a typical camera yet detects infrared energy or heat rather than light. In typical thermal images, the surface temperature of an object is expressed in such a manner that thousands of points are mapped to different colors according to the temperature difference.

In particular, each type of gas has a different temperature. Thus, according to the temperature expressed on an image photographed by the infrared camera 114, the type of gas can be identified.

These visible-light cameras 112 are integrally formed with the infrared cameras 114, so that a visible-light image and an infrared image can be easily captured in the same region.

Referring to FIG. 3, a plurality of cameras capture images of different regions into which the gas monitoring area 190 is divided. In this case, an angle of view of each camera is preferably adjusted so as to partly overlap with that of the neighboring camera.

Regions A to I shown in FIG. 3 indicate photographing regions of the cameras, and a region indicated by slanted lines is a portion where neighboring regions overlap with each other. In this manner, by overlapping the regions of photography of the plurality of cameras, an entire area to be monitored can be completely covered.

Further, the camera set 110 further includes a camera driver (not shown) that can control focusing and tracking operations of the visible-light cameras 112 and the infrared cameras 114 under the control of the control unit 150.

Any one of the cameras rotates at an angle of 360° to photograph the gas monitoring area 190. Visible-light images and infrared images which the camera captures while rotating at an angle of 360° are output to an administrator terminal 200. Here, the control unit 150 processes the captured images into a panorama image file so as to be continuously displayed on the administrator terminal 200.

The composite image coupling unit 120 couples the visible-light images captured by the visible-light cameras 112 and the infrared images captured by the infrared cameras 114. When a temperature of a specific gas which was previously stored in a database (DB) is detected, the composite image coupling unit 120 extracts gas leakage points 192 from the coupled infrared images, and makes a composite of the extracted gas leakage points 192 and the visible-light images.

To this end, the composite image coupling unit 120 includes a visible-light image coupler 122, an infrared image coupler 124, a gas leak extractor 126, and an image compositor 128.

The visible-light image coupler 122 couples the visible-light images captured by the visible-light cameras 112. The visible-light images can be coupled using a typical algorithm.

The visible-light image coupler 122 can couple the visible-light images by checking an overlapping portion of each visible-light image (a portion indicated by slant lines in FIG. 3), conducting boundary detection, and then conducting pattern matching.

That is, the visible-light image coupler 122 calculates pixel positions for joining the visible-light images, and couples the visible-light images on the basis of the calculated pixel positions.

Further, the infrared image coupler 124 couples the infrared images captured by the infrared cameras 114 using information which the visible-light image coupler 122 uses to couple the visible-light images.

That is, the infrared image coupler 124 couples the infrared images on the basis of the pixel positions calculated to couple (join) the visible-light images by the visible-light image coupler 122.

If the infrared images have a lower resolution than the visible-light images, the infrared image coupler 124 conducts decimation on the pixel positions calculated by the visible-light image coupler 122, calculates pixel positions of the infrared images, and couples the infrared images on the basis of the calculated pixel positions of the infrared images.

For example, it is assumed that the visible-light images have a resolution of M×N and that the infrared images have a resolution of m×n (where M=am and N=bn (a and b are rational numbers). If the visible-light images are coupled so as to overlap by x1 in an x-axial direction, the infrared images are coupled so as to overlap by x1/a in the x-axial direction.

The gas leak extractor 126 extracts gas leakage points 192, at which the temperature of a specific gas which was previously stored in a DB is detected, from the infrared images coupled by the infrared image coupler 124.

The image compositor 128 makes a composite of the gas leakage points 192 extracted by the gas leak extractor 126 and the visible-light images coupled by the visible-light image coupler 122.

That is, the visible-light images are overlaid with the gas leakage points 192 of the infrared images, and preferably the transparency is allowed to be set.

The screen output unit 130 outputs the composite images created by the composite image coupling unit 120 to the administrator terminal 200 so that an administrator can ascertain the images. The administrator can monitor the gas monitoring area 190 in real time using the administrator terminal 200.

The control unit 150 analyzes the type of gas and a range of gas leakage from the temperature of the specific gas detected at the gas leakage points 192.

Further, when the temperature of the specific gas which was previously stored in the DB is detected by the composite image coupling unit 120, the control unit 150 records the visible-light images and the infrared images, and stores the recorded images in a storage unit 160. Here, the control unit 150 may store an image, which the image compositor 128 makes by creating a composite of the gas leakage points 192 and the visible-light image, in the storage unit 160.

An administrator analyzes the images stored in the storage unit 160 later in the future, and accurately discovers a gas leak time and the gas leakage points 192, so that the images can be used as information to carry out maintenance.

Further, the control unit 150 analyzes the type of gas and the range of gas leakage to determine a gas leakage state as being safe or dangerous, and controls a warning unit 140 so as to enable persons located at the gas monitoring area 190 and an administrator of the gas monitoring area to escape from or repair the gas leakage points in accordance with the gas leakage state.

Meanwhile, the control unit 150 determines that the gas leakage state is a safe one when the specific gas leaking from the gas leakage points 192 does not cause a response in the human body and when a quantity of leakage of the gas is less than a predetermined amount. The control unit 150 controls the screen output unit 130 so as to output the gas leakage points 192 from which the gas leaks, the sort of gas, and the gas leakage area to the administrator terminal 200, and informs an administrator so as to be able to repair the gas leakage points 192.

In contrast, when the specific gas leaking from the gas leakage points 192 causes a response in the human body and when a temperature corresponding to the temperature of the human body is detected from the specific gas, the control unit 150 determines that the gas leakage state is dangerous. The control unit 150 controls the screen output unit 130 so as to output the gas leakage points 192 from which the gas is leaking, the type of gas, and the range of gas leakage to the administrator terminal 200, and informs an administrator so as to be able to repair the gas leakage points 192. Simultaneously, the control unit 150 controls the warning unit 140 so as to output a warning sound and announcement to persons located at the gas leakage points 192 and to enable the persons to escape from the gas leakage points 192.

Referring to FIG. 4, when the temperature of the specific gas which was previously stored in the DB is detected using the composite image coupling unit 120, the control unit 150 determines that the gas leakage state is dangerous on the basis of the type of specific gas leaking from the gas leakage points 192 and the range of gas leakage. In this case, the control unit 150 turns on and off a pilot lamp 170 so as to enable persons located at the gas monitoring area 190 to discover the position of the storage cabinet 172 in which gas masks 174 are stored.

Thereby, the persons located near the gas monitoring area 190 look at the light of the pilot lamp 170 that is being turned on and off, easily discover the position of the storage cabinet 172 in which gas masks 174 are stored, move to the storage cabinet 172, and wear the gas masks 174.

Further, when the camera set 110 monitoring the gas monitoring area 190 is installed in a building or a specific area, and when the temperature of the specific gas which was previously stored in the DB is detected by the composite image coupling unit 120, the control unit 150 controls a message sending module 180 so as to escape from the gas monitoring area 190 within a shortest time, and so as to send a text message to mobile phones of persons who are in the building or the specific area previously stored in the DB to inform them about the gas leakage.

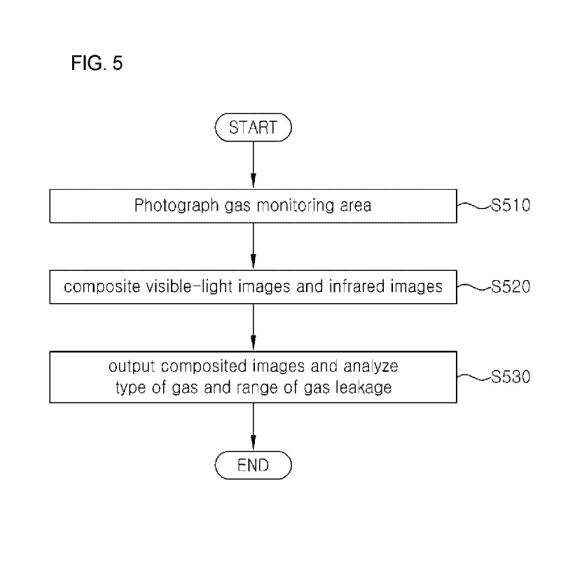

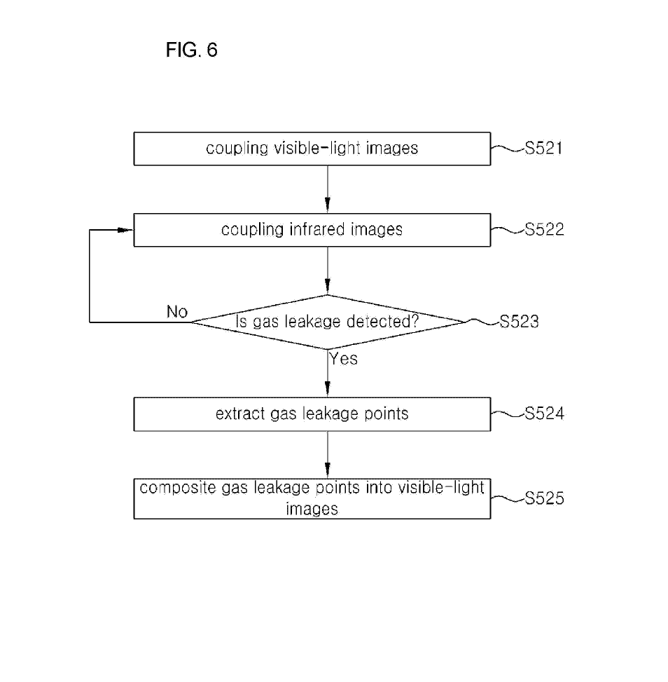

FIG. 5 is a flow chart showing a gas leakage detecting method according to an exemplary embodiment of the present invention, and FIG. 6 is a flow chart showing an image composition process of the gas leakage detecting method according to the exemplary embodiment of the present invention.

In the gas leakage detecting method according to an exemplary embodiment of the present invention, first, the camera set 110 including the visible-light cameras 112 and the infrared cameras 114 photographs the gas monitoring area 190 (S510).

Here, each visible-light camera 112 refers to a typical camera that acquires video information based on light detection.

Each infrared camera 114 is a thermal imaging camera, and is different from the typical camera because although it operates like a typical camera, it detects infrared energy or heat rather than light. In typical thermal images, the surface temperature of an object is expressed in such a manner that thousands of points are mapped to different colors according to the temperature difference.

In particular, each type of gas has a different temperature. Thus, according to the temperature expressed on an image photographed by the infrared camera 114, the type of gas can be identified.

These visible-light cameras 112 are integrally formed with the infrared cameras 114, so that a visible-light image and an infrared image can be easily captured in the same region.

Further, the camera set 110 further includes a camera driver (not shown) that can control focusing and tracking operations of the visible-light cameras 112 and the infrared cameras 114 under the control of the control unit 150.

Any one of the cameras rotates at an angle of 360° to photograph the gas monitoring area 190. Visible-light images and infrared images which the camera captures while rotating by the 360° angle are output to an administrator terminal 200. Here, the control unit 150 processes the captured images into a panorama image file so that they are displayed in continuation on the administrator terminal 200.

Then, the composite image coupling unit 120 couples the visible-light images captured by the visible-light cameras 112 and the infrared images captured by the infrared cameras 114. When a temperature of a specific gas which was previously stored in a database (DB) is detected, the composite image coupling unit 120 extracts gas leakage points 192 from the coupled infrared images, and creates a composite of the extracted gas leakage points 192 and the visible-light images (S520).

That is, the visible-light image coupler 122 of the composite image coupling unit 120 couples the visible-light images captured by the visible-light cameras 112 (S521). To this end, the visible-light image coupler 122 calculates the pixel positions used to join the visible-light images, and couples the visible-light images on the basis of the calculated pixel positions.

Further, the infrared image coupler 124 couples the infrared images captured by the infrared cameras 114 using information which the visible-light image coupler 122 uses to couple the visible-light images (S522). Here, the resolution of the infrared images is lower than that of the visible-light images, and the infrared image coupler 124 conducts decimation on the pixel positions to calculate pixel positions of the infrared images, and couples the infrared images on the basis of the calculated pixel positions of the infrared images.

Subsequently, the gas leak extractor 126 determines that a temperature of a specific gas which was previously stored in a DB is detected (S523), and extracts gas leakage points 192 from the infrared images coupled by the infrared image coupler 124 (S524).

Then, the image compositor 128 creates a composite of the gas leakage points 192 extracted by the gas leak extractor 126 and the visible-light images coupled by the visible-light image coupler 122 (S525).

The images composited by the composite image coupling unit 120 are output to the administrator terminal 200, and the control unit 150 analyzes the type of gas and the range of gas leakage from the temperature of the specific gas detected at the gas leakage points 192 (S530).

Further, when the temperature of the specific gas which was previously stored in the DB is detected by the composite image coupling unit 120, the control unit 150 records the visible-light images and the infrared images, and stores the recorded images in the storage unit 160. Here, the control unit 150 may store an image, which the image compositor 128 created by making a composition of the gas leakage points 192 and the visible-light image, in the storage unit 160.

An administrator analyzes the images stored in the storage unit 160 later in the future, and accurately ascertains a gas leak time and the gas leakage points 192, so that the images can be used as information to carry out maintenance.

Further, the control unit 150 analyzes the type of gas and the range of gas leakage to determine the gas leakage state as being either safe or dangerous, and controls the warning unit 140 so as to enable persons located in the gas monitoring area 190 and an administrator of the gas monitoring area to escape from or repair the gas leakage points depending on the gas leakage state.

Meanwhile, the control unit 150 determines that the gas leakage state is safe when the specific gas leaking from the gas leakage points 192 does not have an influence on the human body and when a quantity of leakage of the gas is less than a predetermined value. The control unit 150 controls the screen output unit 130 so as to output the gas leakage points 192 from which the gas leaks, the type of gas, and the range of gas leakage to the administrator terminal 200, and informs an administrator so that the gas leakage points 192 can be repaired.

In contrast, when the specific gas leaking from the gas leakage points 192 gives a stimulus to a human body and when a temperature corresponding to a temperature of the human body is detected from the specific gas, the control unit 150 determines that the gas leakage state is dangerous. The control unit 150 controls the screen output unit 130 so as to output the gas leakage points 192 from which the gas is leaking, the type of gas, and the range of gas leakage to the administrator terminal 200, and informs an administrator so that the gas leakage points 192 can be repaired. Simultaneously, the control unit 150 controls the warning unit 140 so as to output a warning sound and announcement to persons located at the gas leakage points 192 to enable the persons to flee the gas leakage points 192.

Referring to FIG. 4, when the temperature of the specific gas which was previously stored in the DB is detected by the composite image coupling unit 120, the control unit 150 determines that the gas leakage state is a dangerous one on the basis of the type of the specific gas leaking from the gas leakage points 192 and the range of gas leakage area. In this case, the control unit 150 turns on and off the pilot lamp 170 so as to enable persons located at the gas monitoring area 190 to discover the position of the storage cabinet 172 in which the gas masks 174 are stored.

Thereby, the persons located near the gas monitoring area 190 look at light of the pilot lamp 170 that is being turned on and off to easily find the position of the storage cabinet 172 in which gas masks 174 are stored, move to the storage cabinet 172, and put on the gas masks 174.

Further, when the camera set 110 monitoring the gas monitoring area 190 is installed in a building or a specific area, and when the temperature of the specific gas which was previously stored in the DB is detected by the composite image coupling unit 120, the control unit 150 controls the message sending module 180 so as to escape from the gas monitoring area 190 within the shortest amount of time, and so as to send a text message to inform about the gas leakage to mobile phones of persons who are in the building or the specific area previously stored in the DB.

Further, when the temperature of the specific gas which was previously stored in the DB is detected by the composite image coupling unit 120, the control unit 150 records the visible-light images and the infrared images, and stores the recorded images in the storage unit 160. Here, the control unit 150 may store an image, which the image compositor 128 makes by creating a composite of the gas leakage points 192 and the visible-light image, in the storage unit 160.

An administrator analyzes the images stored in the storage unit 160 later in the future, and accurately ascertains a gas leak time and the gas leakage points 192, so that the images can be used as information to carry out maintenance.

Further, the control unit 150 analyzes the type of gas and the range of gas leakage to determine a gas leakage state as being safe or dangerous, and controls the warning unit 140 so as to enable persons located in the gas monitoring area 190 and an administrator of the gas monitoring area to escape from or repair the gas leakage points depending on the gas leakage state.

Meanwhile, the control unit 150 determines that the gas leakage state is safe when the specific gas leaking from the gas leakage points 192 does not have an influence on the human body and when a quantity of gas leaked is less than a predetermined amount. The control unit 150 controls the screen output unit 130 so as to output the gas leakage points 192 from which the gas leaks, the type of gas, and the range of gas leakage to the administrator terminal 200, and informs an administrator so that the gas leakage points 192 can be repaired.

In contrast, when the specific gas leaking from the gas leakage points 192 has an influence on the human body and when a temperature corresponding to the temperature of the human body is detected in the specific gas, the control unit 150 determines that the gas leakage state is a dangerous one. The control unit 150 controls the screen output unit 130 so as to output the gas leakage points 192 from which the gas is leaking, the type of gas, and the range of gas leakage to the administrator terminal 200, and informs an administrator so that the gas leakage points 192 can be repaired. Simultaneously, the control unit 150 controls the warning unit 140 so as to output a warning sound and announcement to persons located at the gas leakage points 192 and to enable the persons to flee the gas leakage points 192.

Referring to FIG. 4, when the temperature of the specific gas which was previously stored in the DB is detected by the composite image coupling unit 120, the control unit 150 determines that the gas leakage state is dangerous on the basis of the type of the specific gas leaking from the gas leakage points 192 and the range of gas leakage. In this case, the control unit 150 turns on and off the pilot lamp 170 so that persons located in the gas monitoring area 190 can discover the position of the storage cabinet 172 in which the gas masks 174 are stored.

Thereby, the persons located near the gas monitoring area 190 look at light of the pilot lamp 170 that is being turned on and off, easily determine the position of the storage cabinet 172 in which gas masks 174 are stored, move to the storage cabinet 172, and put on the gas masks 174.

Further, when the camera set 110 monitoring the gas monitoring area 190 is installed in a building or a specific area, and when the temperature of the specific gas which was previously stored in the DB is detected by the composite image coupling unit 120, the control unit 150 controls the message sending module 180 so as to flee the gas monitoring area 190 within the shortest amount of time, and sends a text message informing about the gas leak to mobile phones of persons who are in the building or the specific area previously stored in the DB.

While the present invention has been particularly shown and described with reference to exemplary embodiments thereof, it will be understood by those of ordinary skill in the art that various changes in form and the details may be made therein without departing from the spirit and scope of the present invention as defined by the following claims. The detailed description and accompanying drawings are to be regarded as merely illustrative, rather than as restrictive. Therefore, the scope of the present invention is defined by the attached claims rather than the foregoing description, and all modifications or changes, if any, are interpreted as falling within the scope of the present invention as described and set forth herein.

What is claimed is:

1. A gas leakage detecting system for detecting leaking gas, comprising:
a camera set having visible-light cameras and infrared cameras photographing a gas monitoring area;
a composite image coupling unit that couples visible-light images captured by the visible-light cameras and infrared images captured by the infrared cameras, extracts gas leakage points from the coupled infrared images when a temperature of a specific gas, which was previously stored in a database (DB), is detected, and makes a composite of the extracted gas leakage points and visible-light images to create composite images;
a screen output unit outputting the composite images created by the composite image coupling unit to an administrator terminal so as to enable an administrator to ascertain the composite images; and
a control unit analyzing a type of the gas and a range of gas leakage from the temperature of the specific gas detected at the gas leakage points,
wherein the control unit records the visible-light images and the infrared images, and stores the recorded images in a storage unit when the temperature of the specific gas which was previously stored in the DB is detected by the composite image coupling unit.

2. The gas leakage detecting system according to claim 1, wherein the camera set further includes a camera driver that is allowed to control focusing and tracking operations of the visible-light cameras and the infrared cameras.

3. The gas leakage detecting system according to claim 1, wherein:
any one of the cameras rotates by an angle of 360° to photograph the gas monitoring area; and
when the visible-light images and the infrared images which the camera captures while rotating by an angle of 360° are output to the administrator terminal, the control unit processes the captured images into a panorama image file so as continuously display the captured images on the administrator terminal.

4. The gas leakage detecting system according to claim 1, wherein the composite image coupling unit includes:
a visible-light image coupler coupling the visible-light images captured by the visible-light cameras;
an infrared image coupler coupling the infrared images captured by the infrared cameras using information which the visible-light image coupler uses to couple the visible-light images;
a gas leak extractor extracting the gas leakage points, from which the temperature of the specific gas previously stored in the DB is detected, from the infrared images coupled by the infrared image coupler; and
an image compositor making a composite of the gas leakage points extracted by the gas leak extractor and the visible-light images coupled by the visible-light image coupler.

5. The gas leakage detecting system according to claim 4, wherein the visible-light image coupler calculates pixel positions to join the visible-light images, and couples the visible-light images based on the calculated pixel positions.

6. The gas leakage detecting system according to claim 5, wherein:
the infrared images have a resolution lower than that of the visible-light images; and
the infrared image coupler conducts decimation on the pixel positions calculated by the visible-light image coupler, calculates pixel positions of the infrared images, and couples the infrared images based on the calculated pixel positions of the infrared images.

7. The gas leakage detecting system according to claim 1, wherein the control unit analyzes the type of the gas and the range of gas leakage to determine a gas leakage state as being safe or dangerous, and controls a warning unit so as to enable persons located at the gas monitoring area and an administrator of the gas monitoring area to escape from or repair the gas leakage points according to the gas leakage state.

8. The gas leakage detecting system according to claim 7, wherein the control unit:
determines that the gas leakage state is safe when the specific gas leaking from the gas leakage points does not have an influence on a human body and when a quantity of gas leaked is less than a predetermined value, controls the screen output unit so as to output the gas leakage points from which the gas leaks, the type of the gas, and the range of gas leakage to the administrator terminal, and informs an administrator so that the gas leakage points can be repaired; and
determines that the gas leakage state is dangerous when the specific gas leaking from the gas leakage points has an influence on a human body and when a temperature corresponding to a temperature of the human body is detected from the specific gas, controls the screen output unit so as to output the gas leakage points from which the gas is leaking, the type of the gas, and the range of gas leakage to the administrator terminal, and informs an administrator so as to be able to repair the gas leakage points, and simultaneously controls the warning unit so as to output a warning sound and announcement to persons located at the gas leakage points and to enable the persons to escape from the gas leakage points.

9. The gas leakage detecting system according to claim 8, wherein, when the control unit determines that the gas leakage state is dangerous, the control unit turns on and off a pilot lamp so as to enable persons located at the gas monitoring area to discover a position of a storage cabinet in which gas masks are stored.

10. The gas leakage detecting system according to claim 1, wherein, when the camera set monitoring the gas monitoring area is installed in a building or a specific area, and when the temperature of the specific gas which was previously stored in the DB is detected by the composite image coupling unit, the control unit controls a message sending module so as to allow people who are in the building or the specific area previously stored in the DB to escape from the gas monitoring area within a shortest amount of time and so as to send a text message to mobile phones of the people in order to inform the people about a gas leakage.

11. A gas leakage detecting method comprising the processes of:
(a) photographing a gas monitoring area using a camera set having visible-light cameras and infrared cameras;
(b) coupling visible-light images captured by the visible-light cameras and infrared images captured by the infrared cameras, extracting gas leakage points from the coupled infrared images when a temperature of a specific gas, which was previously stored in a database (DB), is detected, and making a composite of the extracted gas leakage points and the composite visible-light images to create composite images; and
(c) outputting the composite images created in the process (b) to an administrator terminal and analyzing, by a control unit, a type of the gas and a range of gas leakage from the temperature of the specific gas detected from the gas leakage points,
wherein the control unit records the visible-light images and the infrared images, and stores the recorded images in a storage unit when the temperature of the specific gas which was previously stored in the DB is detected in the process (b).

12. The gas leakage detecting method according to claim 11, wherein the camera set further includes a camera driver that is allowed to control focusing and tracking operations of the visible-light cameras and the infrared cameras.

13. The gas leakage detecting method according to claim 11, wherein:
any one of the cameras rotates by an angle of 360° to photograph the gas monitoring area; and
when the visible-light images and the infrared images which the camera captures while rotating by an angle of 360° are output to the administrator terminal, the control unit processes the captured images into a panorama image file so as to be continuously displayed on the administrator terminal.

14. The gas leakage detecting method according to claim 11, wherein the process (b) includes the sub-processes of:
(b1) coupling, by a visible-light image coupler, the visible-light images captured by the visible-light cameras;
(b2) coupling, by an infrared image coupler, the infrared images captured by the infrared cameras using information which the visible-light image coupler uses to couple the visible-light images;
(b3) extracting the gas leakage points, from which the temperature of the specific gas previously stored in the DB is detected, from the infrared images coupled in the sub-process (b2); and
(b4) making a composite of the gas leakage points extracted in the sub-process (b3) and the visible-light images coupled by the visible-light image coupler.

15. The gas leakage detecting method according to claim 14, wherein the sub-process (b1) includes calculating pixel positions used to join the visible-light images, and coupling the visible-light images based on the calculated pixel positions.

16. The gas leakage detecting method according to claim 15, wherein in the sub-process (b2):
the infrared images have a resolution lower than that of the visible-light images; and
the infrared image coupler conducts decimation on the pixel positions calculated by the visible-light image coupler, calculates pixel positions of the infrared images, and couples the infrared images based on the calculated pixel positions of the infrared images.

17. The gas leakage detecting method according to claim 11, wherein the control unit analyzes the type of the gas and the range of gas leakage to determine a gas leakage state as being safe or dangerous, and controls a warning unit so as to enable persons located at the gas monitoring area and an administrator of the gas monitoring area to escape from or repair the gas leakage points according to the gas leakage state.

18. The gas leakage detecting method according to claim 17, wherein the control unit:
determines that the gas leakage state is safe when the specific gas leaking from the gas leakage points has no influence on a human body and when a quantity of gas leaked is less than a predetermined value, controls the screen output unit so as to output the gas leakage points from which the gas leaks, the type of the gas, and the range of gas leakage to the administrator terminal, and informs an administrator so that the gas leakage points can be repaired; and
determines that the gas leakage state is dangerous when the specific gas leaking from the gas leakage points has an influence on a human body and when a temperature corresponding to a temperature of the human body is detected from the specific gas, controls the screen output unit so as to output the gas leakage points from which the gas is leaking, the type of the gas, and the range of gas leakage to the administrator terminal, and informs an administrator so that the gas leakage points can be repaired, and simultaneously controls the warning unit so as to output a warning sound and announcement to persons located at the gas leakage points and to enable the persons to escape from the gas leakage points.

19. The gas leakage detecting method according to claim 18, wherein, when the control unit determines that the gas leakage state is dangerous, the control unit turns on and off a pilot lamp so as to enable persons located in the gas monitoring area to discover a position of a storage cabinet in which gas masks are stored.

20. The gas leakage detecting method according to claim 11, wherein, when the camera set monitoring the gas monitoring area is installed in a building or a specific area, and when the temperature of the specific gas which was previously stored in the DB is detected in the process (b), the control unit controls a message sending module so as to allow people who are in the building or the specific area previously stored in the DB to escape from the gas monitoring area within a shortest amount of time and so as to send a text message for informing the people about a gas leakage to mobile phones of the people.
